(19) United States
(12) Patent Application Publication
(10) Pub. No.: US 2009/0198591 A1
(43) Pub. Date: Aug. 6, 2009

(54) Methods and systems for providing auctions and related broadcast communications

(76) Inventors: Michael Loeb, New York, NY (US); Edward McCabe, Yonkers, NY (US)

Correspondence Address: EDWARDS ANGELL PALMER & DODGE LLP, P.O. BOX 55874, BOSTON, MA, 02205, US

(21) Appl. No.: 12/336,924

(22) Filed: Dec. 17, 2008

Related U.S. Application Data
(60) Provisional application No. 61/014,141, filed on Dec. 17, 2007.

(51) Int. Cl. G06Q 30/00; G06Q 20/00; G06Q 50/00; G06F 15/16

(52) U.S. Cl. 705/26; 709/204; 709/206

(57) ABSTRACT

A computer-implemented method for conducting an auction of an item associated with an event. The method includes the steps of receiving registration information from charitable organizations, donor organizations, and bidders through a network, storing the registration information on a server, matching one or more of the charitable organizations to one or more of the donor organizations and to an event based on the registration information stored on the server, conducting an auction of an item associated with the event concurrently with the event by receiving bids submitted by the bidders through the network, and securely collecting a payment for the winning bid through the network and automatically transferring at least a portion of the payment to one or more of the charitable organizations. Bidding in the auction is open during the event and closes after the event ends, and the value of the item is directly affected by occurrences during the event.

### CROSS REFERENCE TO RELATED APPLICATION

This application claims priority to U.S. Provisional Patent Application No. 61/014,141, filed Dec. 17, 2007.

### BACKGROUND OF THE INVENTION

1. Field of the Invention

The present invention relates to methods and systems for simultaneously providing a real-time auction through a plurality of broadcast channels. More specifically, the present invention relates to methods and systems for simultaneously providing a real-time auction of memorabilia or other goods associated with a particular event for the benefit of a not-for-profit or other organization.

2. Description of the Related Art

Charitable organizations that operate on a not-for-profit basis such as schools, universities, churches, and civic groups must maintain sufficient funds to continue operation and to further the goals of the organization. The need to raise sufficient funds is a constant concern for these organizations. Traditional approaches to raising funds have including selling food, apparel, or other items at a significant mark-up, providing incentives in the form of gift items based on a level of donation, auctioning off items or services related to the organization, and directly soliciting cash donations by appealing to the potential donor's sense of obligation to the organization. These approaches have been used, with varying degrees of success, in a wide variety of communication channels, including in person, by phone, by email, and online.

Auctions have been a popular method of raising money for charitable organizations. Such auctions may be live or silent, and are often held in conjunction with an event associated with the charitable organization. These auctions are generally held a limited number of times per year and require a large amount of planning on the part of the organizer prior to the event to handle marketing, communications, bids, donations, receipts, and delivery of merchandise, among other things. The Internet has reduced the burden of running such auctions, allowing individuals to use third-party providers to run online charitable auctions where many administrative tasks are handled by a centralized online auction platform. Such auction platforms have reduced the costs of holding auctions and have performed fairly well, but generally do not provide sufficient marketing and communication platforms to maximize the bids and thus the donations to the charitable organization.

Charitable organizations often have a large untapped donor base, that is, people who are affiliated with, or have an affinity for, the organization but have failed to make a donation to the organization. A natural aversion to giving money away, even for a good cause, provides a partial explanation for this large untapped donor base. However, the primary reason for the large disparity between potential donors and actual donors may simply be inadequate or ineffective marketing and promotion of fundraising efforts. It has been found that the likelihood that an individual will donate money to a charitable organization increases when the requested donation amount is lowered, when the organization can articulate a specific use of the donation that resonates with the potential donor, and/or when the organization is able to provide some kind of incentive for making a donation.

Consequently, there is a need for systems and methods that effectively provide creative marketing, communications, and payment options that will allow charitable organizations to maximize the effectiveness of fundraising auctions and thus maximize donations to the organization.

### SUMMARY OF THE INVENTION

A computer-implemented method for conducting an auction of an item associated with an event. The method includes the steps of receiving registration information from charitable organizations, donor organizations, and bidders through a network, storing the registration information on a server, matching one or more of the charitable organizations to one or more of the donor organizations and to an event based on the registration information stored on the server, and conducting an auction of an item associated with the event concurrently with the event by receiving bids submitted by the bidders through the network. In one exemplary embodiment, the method includes the step of securely collecting a payment for the winning bid through the network and automatically transferring at least a portion of the payment to one or more of the charitable organizations. Bidding in the auction is open during the event and closes after the event ends, and the value of the item is directly affected by occurrences during the event.

A system for conducting an auction of an item associated with an event, is also provided. The system includes a server adapted and configured to receive registration information from charitable organizations, donor organizations, and bidders through a network, and a database adapted and configured to store the registration information received by the server. A matching module runs on the server and is adapted to match one or more of the charitable organizations to one or more of the donor organizations and to an event based on the registration information stored in the database. An auction module also runs on the server and is adapted and configured to conduct an auction through the network concurrently with the event by receiving bids submitted by the bidders through the network. In one exemplary embodiment, a payment module runs on the server. The payment module is adapted and configured to securely collect a payment for the winning bid through the network and to automatically transfer at least a portion of the payment to one or more of the charitable organizations. Bidding in the auction is open during the event and closes after the event ends, and the value of the item auctioned is directly affected by occurrences during the event.

### BRIEF DESCRIPTION OF THE DRAWINGS

So that those skilled in the art to which the subject invention pertains will readily understand how to implement the methods and systems for simultaneously providing a real-time auction through a plurality of broadcast channels disclosed herein without undue experimentation, preferred embodiments of the system and methods will be described in detail below with reference to the following figures:

FIG. 1 is a schematic view illustrating an exemplary embodiment of the system according to the present invention;

FIG. 2 is a flow diagram illustrating an exemplary process allowing a potential bidder to register for use of the system of the present invention;

FIG. 3 is a flow diagram illustrating an exemplary process in which a donor organization registers for and participates in auctions provided by the system of the present invention;

FIG. 4 is a flow diagram illustrating an exemplary method of operation of the system of the present invention in connection with a sporting event such as a football, baseball, or basketball game; and

FIG. 5 is a flow diagram illustrating another method of operating the system of the present invention in connection with a sporting event.

### DETAILED DESCRIPTION OF THE INVENTION

The present invention provides a system for simultaneously providing a real-time auction of memorabilia or other goods associated with a particular event for the benefit of a not-for-profit or other organization. The system allows donors to guarantee goods associated with a scheduled event such as a concert, a party, or a sporting event and then to auction or sell the goods to interested buyers for the benefit of a charitable organization through the use of an intermediary system. The intermediary system handles the marketing, communication, and payment options between the buyer and seller.

The system and methods described are particularly well suited for maximizing donations in the form of auction bids to charitable or educational organizations such as schools, colleges, universities, church groups, and civic groups. However, it should be understood that the methods and systems of the present invention are not limited to auctions that benefit charitable organizations. The methods and systems of the present invention may be used to maximize fundraising in a wide variety of contexts.

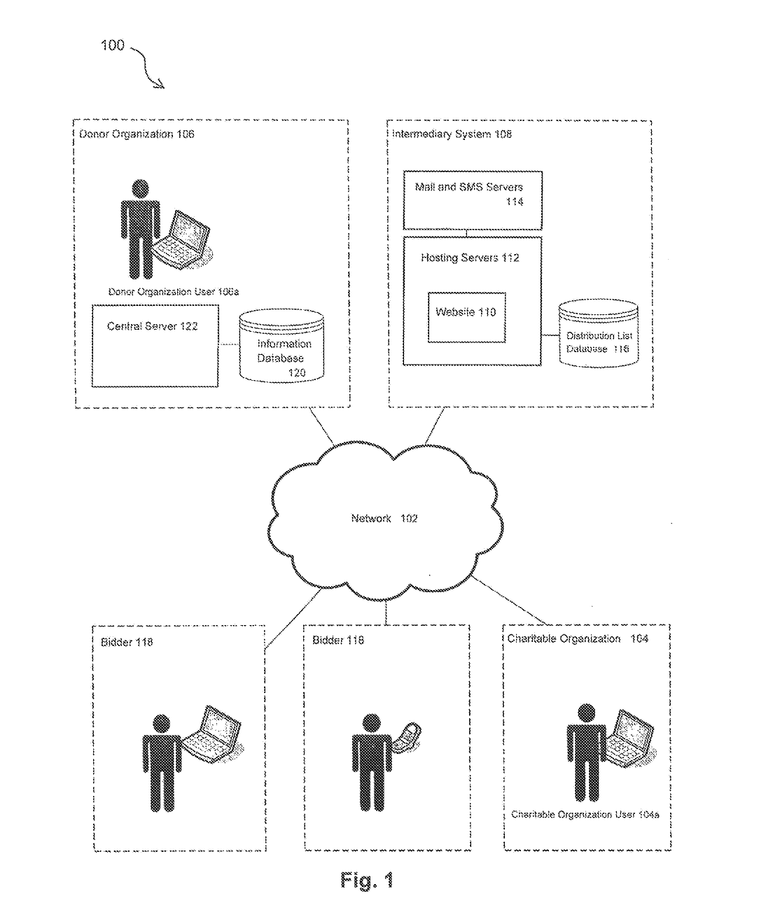

FIG. 1 illustrates a system 100 for simultaneously providing real-time auctions across a network 102 via a wide range of communication channels and communication devices. System 100 may be implemented using hardware and/or software devices. Network 102 preferably includes the Internet and may also include cellular or other wireless networks. In one exemplary embodiment, system 100 provides a platform for conducting auctions for charitable organizations. In the exemplary embodiment shown, a charitable organization 104 interacts with a donor organization 106. Donor organization 106 provides goods, services, memorabilia, or other merchandise for use in an auction to benefit charitable organization 104. Traditionally, charitable organizations were forced to contact potential donors through conventional channels, usually in person or by phone. Using these traditional methods, simply finding organizations willing and able to donate goods to be auctioned for charity is a herculean task consuming significant amounts of time and resources that could otherwise be directed toward accomplishing the core goals of the charitable organization.

System 100 provides a convenient platform that allows charitable organizations 104 and donor organizations 106 to quickly connect to form a mutually beneficial relationship. In one exemplary embodiment, this is accomplished through a third party intermediary system 108, which includes a website 110 that facilitates communication between charitable organizations 104 and donor organizations 106.

Website 110 is hosted within intermediary system 108 on hosting servers 112, which includes software applications that allow website 110 to communicate with mail and Short Message Service (SMS) servers 114 and a distribution list database 116. The homepage of website 110 may have a list of upcoming events and auctions, as well as a list of auctions and events that are currently taking place. Servers 112 operate under the control of an operating system, as is known in the art, to execute one or more computer programs. System 108 may be implemented as one or more computer programs executed by the server. Generally, the computer programs implementing system 108 are tangibly embodied in a computer readable medium, such as a fixed and/or removable data storage device within the server.

Website 110 will have at least three different types of users: 1) charitable organizations 104, 2) donor organizations 106, and 3) individual users or bidders 118. When a user initially visits website 110, the user will be given the opportunity to register as a charitable organization user 104a, as a donor organization user 106a, and/or as an individual bidder 118.

When registering through website 110, a charitable organization user 104a may be prompted to input information about the user's organization. System 108 will then verify the information and allow charitable organization user 104a to create an account that can be accessed through a secure login, for example, by entering a user name and password. Once an account has been created, charitable organization user 104a will be able to set preferences for the charitable organization 104 within intermediary system 108. For example, the charitable organization user 104a may be able to designate the types of events they would like to be affiliated with, the amount of money that the organization needs to raise, and the timeline for raising the money.

Similarly, donor organization users 106a will also be able to register through website 110, create an account, and designate preferences. For example, donor organization user 106a may input information about the events that the donor organization 106 is involved in, and the types of charitable organizations they would like to support. Once donor organization users 106a and charitable organization users 104a have registered their respective organizations, these users will be able to login to system 108 via website 110 and view a personalized web portal for their respective organizations that shows events and auctions that each organization is involved in. The personalized web portal may also show suggested events or auctions that could be of interest based on information entered or based on past participation.

System 100 therefore greatly reduces the resources expended by charitable organizations in locating potential donor organizations for charitable auctions. System 100 is able to efficiently match the goods offered for auction by donor organization 106 with the needs of charitable organization 104. Charitable organizations 104 and donor organizations 106 may be involved in any number of auctions, which will all be tracked by intermediary system 108. Both charitable organizations 104 and donor organizations 106 will be able to monitor the auctions while they occur. However, intermediary system 108 will not require further input from an organization's users once the organization has agreed to participate in the auction. Advantageously, this frees up vital resources of both donor organizations and charitable organizations, allowing each organizations to focus on the tasks that are essential to core goals of the organization rather than focusing on fundraising.

Although system 100 can be used to facilitate matching of charitable organizations 104 to donor organizations 106, it is contemplated that charitable organization 104 and donor organization 106 may be one in the same. A university is one example where this may be the case. The university may decide to raise money for one or more of its departments by auctioning off items associated with a game played by one or more of its athletic teams. Alternatively, charitable organization 104 may have already found potential donors through more traditional means. For example, a charitable organization 104 may already have items that they would like to auction, or the charitable organization may already have sponsors/donors lined up for an event. In these cases, intermediary system 108 is still well-suited to simultaneously conduct the auction through a plurality of communication channels.

Individual users or bidders 118 will also be able to register to participate in charitable auctions through website 110. Bidder 118 will be required to create an account and enter identifying information such as name, email address, address, phone numbers, and the like. Bidder 118 may also be able to fill out a survey indicating their professional and recreational interests and may also be able to designate charitable organizations and/or donor organizations that they would like to be affiliated with. Once an individual bidder 118 has registered, bidder 118 will be able to log in to an individualized web portal that will present the bidder with opportunities to participate in charitable auctions based on the preferences the bidder has set, the answers to the survey questions, and the bidder's past participation and bidding behavior in other auctions. A bidder 118 will also be able to access a preference settings by using a cell phone, smart phone, personal digital assistant (PDA), or any other mobile device.

Bidders 118 may also opt in to receive email or text message blasts related to sports teams of interest, types of merchandise, or buying history. Data concerning participation in auctions, preferences, and buying behavior of bidders 118 is fed back into system 108 and stored in distribution list database 116. If bidders 118 have opted in, each bidder will then receive emails and/or text messages that are individualized, giving each bidder 118 opportunities to participate in auctions for items and events that the bidder has expressed an interest in. The information stored in database 116 may also be used to target development phone calls to raise money for an organization or to sell additional related products to bidder 118.

In one exemplary embodiment, donor organization 106 is affiliated with a specific event and provides goods or services that relate to the event and whose value may vary depending on what happens during the event or on the outcome of the event. When donor organization 106 is closely affiliated with the event, donor organization 106 will be in the best position to provide information concerning the event.

For example, real-time information concerning the event may be maintained by donor organization 106 in an information database 120. Information database 120 is connected to a central server 122 maintained by donor organization 106. Through network 102, central server 122 communicates with hosting servers 112, which host website 110 and are connected to distribution list database 116 and mail and Short Message Service (SMS) servers 114. Information about a specific event is updated in real-time and communicated from central server 122 to hosting server 112. Hosting server 112 then accesses distribution list database 116 to determine which bidders 118 have opted to participate in an auction associated with the event and instruct mail and SMS servers 114 to send messages to each of the individual bidders 118. Alternatively, a third party could provide the real-time information updates concerning the event.

Messages sent to individual bidders 118 may contain updates on the event in progress as well as updates on the current high bids on auction items associated with the event. System 108 may be configured to send email messages, text messages, instant messages, or voice messages. Additionally, bidders 118 may follow the progress of the event and the auctions associated with the event by logging in to their personalized web portal within website 110. System 108 may also be configured to provide updates on the progress of the event and auctions through a micro-blogging service. Bidders 118 may submit a bid on an auction for items associated with an event before, during, and for a set time after the event.

System 108 may be utilized to auction items associated with any type of event. However, system 108 is particularly well suited for auctioning items associated with a sporting event, since the value of the items auctioned could be greatly affected by what happens during the game. For example, system 108 could be used to auction off items associated with a baseball game. The baseball game could be at the professional level, the semi-professional level, the college level, or even at the high school or little league level. A baseball team or parent organization would sign up on website 110 as a donor organization 106 and guarantee to provide items associated with the game such as bats, balls, helmets, hats, gloves, bases, any other equipment used in the game. The baseball team and/or other Donor organizations 106 could also provide additional items for auction, such as merchandise affiliated with one or both of the teams playing in the game. The baseball team would log in to a personalized web portal via website 110 and upload descriptions, photos, and other information regarding the items that are to be auctioned. Bidders 118 would then be allowed to sign up to participate in the auction associated with the game, or would receive messages soliciting their participation. Bidders 118 who agree to participate would then receive periodic messages from system 108 allowing them to bid on the items before the game, during the game, and for a set time after the game ends.

Once the baseball game begins, bidders 118 would receive periodic updates on the progress of the game as well as the progress of the auction. For example, system 108 might send messages to bidders 118 every inning, when a spectacular play is made, or when a run is scored. The messages may include the score of the game, relevant statistics, photos, graphics, audio clips, and any other relevant information. The message sent to bidders 118 would also list the items that are currently being auctioned along with the current high bid for each of the items.

In one exemplary embodiment, system 108 also allows donor organizations 106 and/or charitable organizations 104 to add items available for auction during the course of the game. This feature of system 108 allows the organizations to maximize charitable donations by adding items that gain significance during the game that may not have been particularly significant beforehand. For example, if a lesser-known player were to get a key hit during an important baseball game, donor organization 106 would be able to add items such as the player's bat, jersey, and hat to the auction while the game was still in progress.

In another exemplary embodiment, system 108 also incorporates a “buy it now” or “end this auction” feature. The “buy it now” feature would allow donor organization 106 and/or charitable organization 104 to set a price at which a bidder 118 could end the auction by submitting a bid at the set price. It is anticipated that the set price would be well above what the charitable organization 104 would normally expect to receive for the item that is being auctioned, thus providing another way to maximize charitable donations.

As the game progresses, the perceived value of the items being auctioned may change. For example, if donor organization were to auction off the hat and jersey worn by the starting pitcher for one of the teams involved in the baseball game, the value of the hat and jersey, and thus the amount of the bids, would increase depending on the pitcher's performance. If the pitcher just didn't have his best stuff and was chased out of the ball game in the third inning, it would be expected that the particular jersey and hat would not generate high bids. However, if the pitcher were to take a no-hitter into the late innings, it would be expected that a large number of people would be bidding a large amount of money for a chance to own a piece of history.

In one exemplary embodiment, bidders 118 would be given a credit for submitting a bid prior to the start of the game. For example, system 108 could automatically increase a submitted bid by 10%, at no extra charge to the bidder, if the bid is submitted up to a week before the game. The automatic increase would gradually diminish as the game time approached. For example, if a bidder were to bid $100 for a certain player's bat a week before the game, his bid would automatically be increased to $110. If he were to submit the bid one day before the game, his bid would automatically increase to $105. If he were to submit the bid within an hour of the start of the game, his bid might automatically increase to $101. In each case, the bidder would pay only $100 if he were to win the auction. Thus, system 100 would reward bidders 118 for bidding early and guaranteeing a minimum price for which the item would be sold.

System 100 allows bidders 118 to continue submitting bids throughout the course of the game. The auction would close at the end of the game or shortly thereafter. In one exemplary embodiment, system 108 sends out messages to all bidders 118 for a given auction as soon as the game has ended and gives the bidders one final chance to submit a bid on the items being auctioned. System 108 may provide additional incentives for submitting bids prior to the start of the game. For example, those bidders who have submitted bids prior to the game may receive more information than those bidders who began bidding during the game, such as the number of participants in the auction and the frequency of bids. Similarly, if two identical high bids were received by system 108, a bidder who submitted the earliest bid would automatically win.

In addition, system 100 may provide means for selling chances to win additional memorabilia or merchandise through a raffle. At the end of the game, all bidders 118 would receive a message giving them a chance to purchase an electronic raffle ticket giving them a chance to win an additional item associated with the game. Items to be raffled off may or may not be associated with the game that was played. For instance, a raffle might be held to give away a game ball used during the game, or to give away official team merchandise.

System 100 one may be used with several different auction models. In one exemplary embodiment, system 100 provides for a sealed bid or blind auction of the items associated with the game or event. In this type of auction, bidders 118 simultaneously submit bids through system 108 without knowledge of the amount bid by the other bidders. The highest bidder 118 wins the auction and will receive the items. The winner may pay either the amount bid, or an amount equal to the highest non-winning bid. In this embodiment, bidders 118 submit a baseline bid and then are given a predetermined number of chances to edit their bid based upon the action that is happening on the field during the game. For example, the bidder may initially guarantee a bid of $50 and be given 5 chances to edit their bid. The bidder would be allowed to increase or decrease the bid, but would not be able to go below the initial $50 dollar bid, and would not be able to see what other bidders, if any, were bidding for the item. In another exemplary embodiment, system 100 would only allow the bidder to increase their successive bids.

In another exemplary embodiment, system 100 provides for a competitive bid auction of the items associated with the game. In this embodiment, bidders 118 submit bids for the items and are able to see the amount that other bidders are bidding for the item, or at least the high bid, as the game progresses.

Advantageously, system 100 is able to simultaneously provide a real-time auction for the items through a plurality of communication channels, thus increasing the number of potential bidders and the potential donation received. For example, during a baseball game, there may be some bidders 118 following the progress of the game and auction via website 110 or via an instant messaging program. Other bidders 118 may be following the progress of the game and the auction via periodic email messages sent from system 108. Other bidders may be sitting in the ballpark where the game is taking place and receiving text message updates about the auction on a cell phone, PDA, or other mobile device. System 100 could also be adapted for use with television broadcasting channels, either as a part of the broadcast or through enhanced content associated with the television broadcast.

System 100 could be used with a wide variety of events in addition to sporting events. For example, system 100 could be used to auction off items at a concert, a play, an awards ceremony, or any other suitable event. During the broadcast of an awards ceremony, for example, system 100 could provide a real-time auction of dresses or tuxedos worn by celebrities, decorations from the hall where the awards ceremony was taking place, or even the awards themselves. System 100 maximizes donations by leveraging bidder's piqued interest in the event while the event is still going on. System 100 is easily scalable, that is, the system is suitable for a wide variety of events, ranging in size from international events being followed by millions of people across the world to local events that are being followed by only a few dozen.

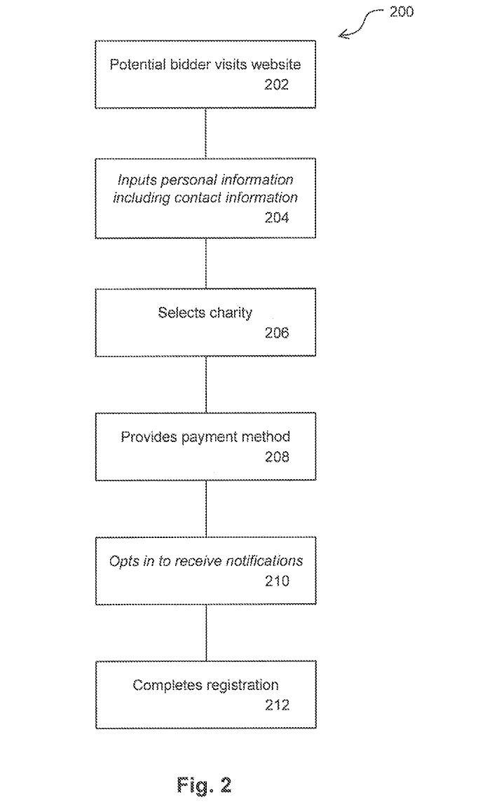

FIG. 2 illustrates a process 200 allowing bidders 118 to register using website 110 to use system 100. In step 202, the potential bidder visits website 110. Website 110 may display a list of games or other events with associated items that will be auctioned. In step 204, the bidder begins the registration process by entering in personal information, including such things as name, email address, cell phone number, address, and the like. System 100 may require verification of the bidder's identity in order to proceed. System 100 may also require that the bidder create a user name and password for secure access to their account on system 108.

At step 206, the bidder is given the opportunity to select a charitable organization to which the proceeds of the auction will be given should the bidder win an auction. In one exemplary embodiment, the bidder is able to choose from a pre-approved list of charitable organizations that have also registered with system 108. In another embodiment, the bidder would be able to submit the name and pertinent information of a charitable organization, which would then be approved or denied by system 108. At step 208, the bidder provides a preferred method of payment. Payment methods could be made by credit card account, a secure online account, or other electronic method. Alternatively, system 108 could be configured to send a bill by fax, email, or regular mail should the consumer win an auction.

In one exemplary embodiment, system 100 is configured to automatically transfer the payment received from bidder 118 to charitable organization 104. A portion of the payment submitted by bidder 118 may be considered a charitable donation, which may qualify for a matching corporate donation. In one exemplary embodiment, system 100 is configured to interface with a system for maximizing charitable donations through matching grants. A portion of the payment received may also be retained by the intermediary system as payment for conducting the auction.

At step 210, system 100 presents the bidder 118 with an opportunity to be added to an opt-in marketing list. Once the bidder is on the marketing list, the bidder will receive text messages, emails, and other communications concerning ongoing and upcoming events and/or auctions related to those events. System 100 will provide the bidder with control over the frequency and type of messages that are received. In one exemplary embodiment, the bidder will be able to choose to receive only messages associated with a specific sports team, a specific event, or a specific charitable organization. System 100 will ideally provide the bidder with a great deal of flexibility in configuring these preferences, allowing the bidder to log in to website 110 and change the preferences when desired. Once the bidder has entered their preferences for receiving messages, the registration process is completed at step 212.

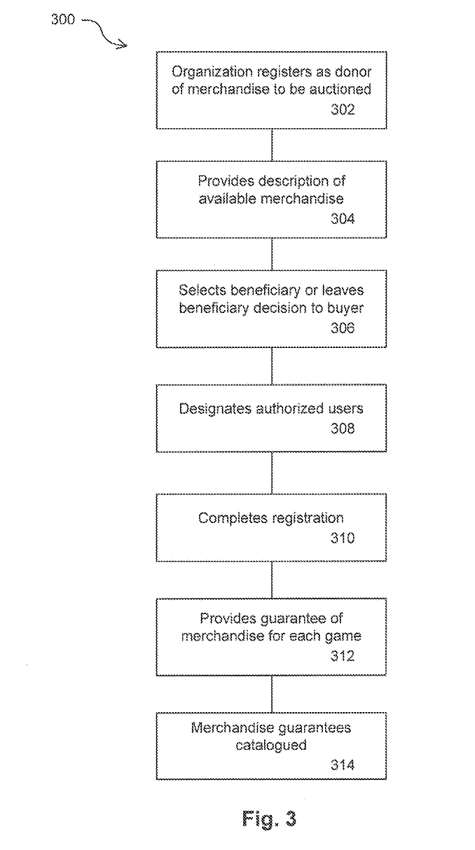

FIG. 3 illustrates a process 300 that allows donor organizations 106 to register and participate in auctions provided by system 100. At step 302, an organization registers as a donor of items to be auctioned by accessing website 110. Initially, the organization may have to create a user name and password to allow secure access to system 108. Website 110 may provide a plurality of portals for each of the potential users of system 100, including donor organizations, charitable organizations, and bidders. At step 304, once the donor organization has logged in to website 110, the organization provides a description of the merchandise that is available for auction, as well as the event that the merchandise is associated with. Step 304 may include entering a text description, and/or uploading photos, video clips, audio clips, or any other suitable media that would enhance the description of the items to be auctioned.

At step 306, system 100 provides the donor organization with the opportunity to select a charitable organization 104 to receive the proceeds from the auction. The donor organization may select one or more charitable organizations, and may choose the percentage of the proceeds that will go to each of the designated charitable organizations. As indicated above, intermediary system 108 may suggest charitable organizations 104 that match specified criteria set by the donor organization 106. Alternatively, system 100 may provide donor organization 106 with the option of allowing the winner of the auction to decide which charitable organization the proceeds will go to.

At step 308, donor organization 106 designates authorized users. That is, the organization can select which group of users registered with website 110 will be eligible to bid during the auction. The registration is completed at step 310, and at step 312 the donor organization provides guarantees of merchandise for each of the games or other events that they have designated. These merchandise guarantees are catalogued by system 108 at step 314.

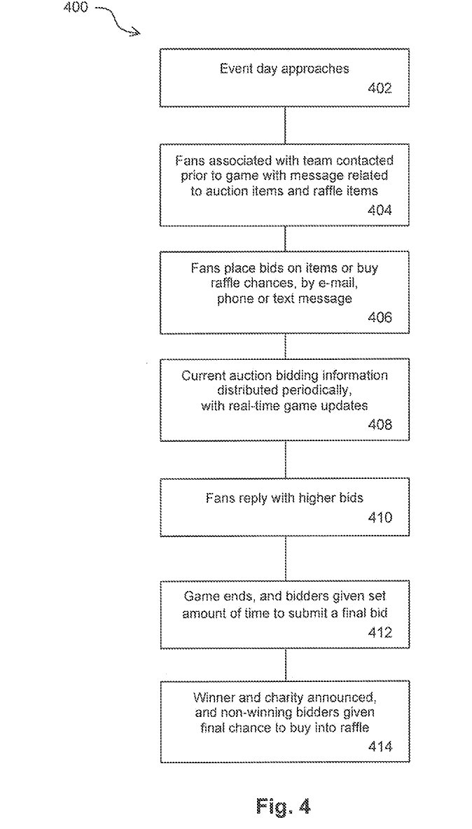

FIG. 4 illustrates a method of operation 400 of system 100 in connection with a sporting event such as a football, baseball, or basketball game. As the day of the event approaches, as shown in step 402, fans associated with the teams that will be playing receive messages related to auction items and raffle items. At step 406, fans place bids on items or purchase raffle chances by email, phone, text message, or other suitable means. At step 408, system 100 distributes updated auction information along with real-time game updates. At step 410, fans respond to the game updates by submitting higher bids for the items that are being auctioned. At step 412, the game ends, and bidders are given a set amount of time to submit a final bid before the auction closes. At step 414, the winner of the auction as well as the charitable organization that will receive the proceeds from the auction are announced through messages sent by system 108. In this step, non-winning bidders are also given a final chance to buy into a raffle for additional items related to the event.

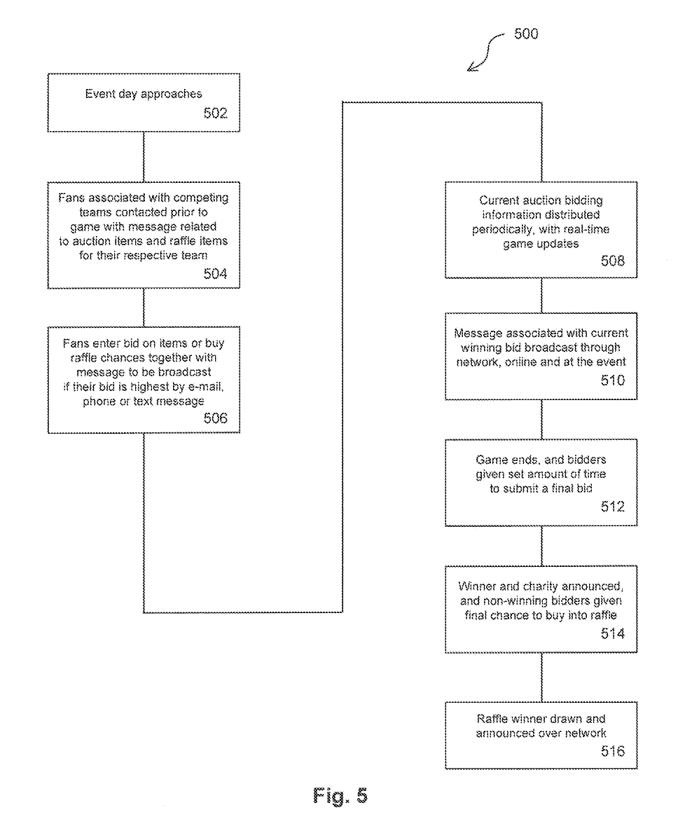

FIG. 5 illustrates a method of operation 500 of system 100 in connection with a sporting event involving at least two competing teams. As the day of the event approaches, as shown in step 502, fans associated with competing teams are contacted prior to the event with messages related to auction items and raffle items for their respective teams. At step 506, fans are able to enter bids on items or buy raffle chances together with a message that will be broadcast by email, phone, text message or other suitable means if their bid is currently the highest or winning bid. In step 508, current auction bidding information is periodically distributed to the bidders, along with real-time game updates. At step 510, a message associated with the current high bid is broadcast through the network, on website 110 and at the event. At step 512, the game ends, and bidders are given a set amount of time to submit a final bid. At step 514, the winner of the auction and the charitable organization that will benefit from the auction are announced, and non-winning bidders are given a final chance to buy into a raffle. At step 516, a raffle winner is drawn and announced over the network. In one exemplary embodiment, the winning bidder 118 would be provided the opportunity to have a final message sent to all other bidders 118. The message may also be displayed at the event on an electronic scoreboard or by other means.

For example, the method 500 described above could be used to promote an auction of items associated with a football game. Donor organization 106 could guarantee to provide auction items such as helmets and jerseys worn by players during the game, game balls, portions of the goal post, portions of sod from an end zone, and any other items associated with the game. In one exemplary embodiment system 108 provides separate auctions, operated in parallel, for each of the teams playing in the football game, with the fans of each team bidding on items associated with their team. System 108 may provide a running total of the auction proceeds generated by each fan base, thus stimulating competition between bidders and maximizing charitable donations.

In another exemplary embodiment, system 100 would allow fans of opposing teams to compete directly for certain items. As an added incentive, a bidder 118 submitting the current high bid would be able to enter a message that would be broadcast through network 102 to each of the other participating bidders 118 as well as at the game on a scoreboard, message board, television broadcast, or the like. This feature would encourage competition between fans of competing teams and thus maximize donations. For example, a fan of one team may submit the high bid just to remove the message previously posted by a fan of the opposing team. The winning bidder would have their message displayed for a set amount of time after the game ends.

The methods and systems of the present invention, as described above and shown in the drawings, simultaneously provide a real-time auction through a plurality of communication channels to maximize the submitted bids for the items being auctioned. Although reference has been made to charitable organizations and sporting events, it will be apparent to those skilled in the art that the methods and systems of the invention could also be used to raise funds and maximize auction returns in other many other contexts. It will also be apparent to those skilled in the art that many variations of the system and methods described above could be implemented without departing from the scope of the invention as set forth in the appended claims and their equivalents.

The invention claimed is:

1. A computer-implemented method for conducting an auction of an item associated with an event, the method comprising:
receiving registration information from charitable organizations, donor organizations, and bidders through a network;
storing the registration information on a server;
matching one or more of the charitable organizations to one or more of the donor organizations and to an event based on the registration information stored on the server; and
conducting an auction of an item associated with the event concurrently with the event by receiving bids submitted by the bidders through the network, wherein bidding in the auction is open during the event and closes after the event ends, and wherein the value of the item is directly affected by occurrences during the event.

2. The method of claim 1, further comprising the step of securely collecting a payment for the winning bid through the network and automatically transferring at least a portion of the payment to one or more of the charitable organizations.

3. The method of claim 2, wherein the step of conducting the auction comprises conducting the auction through a plurality of communication mediums, including at least one of the Internet, a cellular communication network, a satellite network, and a wireless network.

4. The method of claim 1, further comprising the step of providing a plurality of real-time updates to the bidders through the network regarding the progress of both the auction and the event.

5. The method of claim 4, wherein the step of providing the plurality of real-time updates is accomplished using least one of a website, an email message, a text message, a voice message, an RSS feed, a multimedia message, and a micro-blogging service.

6. The method of claim 1, wherein the step of receiving bids from the bidders includes receiving bids from at least one of a website, an email message, a text message, a voice message, a multimedia message, and a micro-blogging service.

7. The method of claim 1, wherein the bidding in the auction opens at a set time prior to the start of the event.

8. The method of claim 1, wherein the bidding in the auction closes immediately after the event ends.

9. The method of claim 1, wherein the bidding in the auction closes a set time after the event ends.

10. The method of claim 1, further comprising the step of broadcasting a message from the current high bidder in the auction to all other bidders participating in the auction.

11. The method of claim 1, further comprising broadcasting a message from the current high bidder in the auction on a display device at the event.

12. The method of claim 1, wherein the event is a sporting event.

13. The method of claim 12, wherein the sporting event involves at least two competing teams, and wherein the step of receiving registration information from each of the bidders includes receiving preferred team affiliation for each registered bidder.

14. The method of claim 13, wherein the item is a plurality of items and wherein each bidder bids only on those items associated with their preferred team.

15. A system for conducting an auction of an item associated with an event, the system comprising:
a server adapted and configured to receive registration information from charitable organizations, donor organizations, and bidders through a network;
a database adapted and configured to store the registration information received by the server;
a matching module running on the server and adapted to match one or more of the charitable organizations to one or more of the donor organizations and to an event based on the registration information stored in the database;
an auction module running on the server and being adapted and configured to conduct an auction through the network concurrently with the event by receiving bids submitted by the bidders through the network, wherein bidding in the auction is open during the event and closes after the event ends, and wherein the value of the item is directly affected by occurrences during the event; and
a payment module running on the server adapted and configured to securely collect a payment for the winning bid through the network and to automatically transfer at least a portion of the payment to one or more of the charitable organizations.

16. A computer-implemented method for conducting an auction of an item associated with an event, the method comprising:
initiating bidding on an item associated with the event by sending a message to a plurality of bidders over a network, wherein the value of the item is directly affected by occurrences during the event;
receiving bids for the item through the network from one or more of the plurality of bidders, wherein at least a portion of the bidding occurs simultaneously with the event;
storing the bids on a server;
comparing the bids stored on the server to determine a current winning bid;
broadcasting information regarding the progress of the auction together with updates on the occurrences in the event over the network to each of the bidders; and
determining the final winning bid and notifying the winning bidder.

17. The method of claim 16, wherein the step of broadcasting information regarding the progress of the auction includes broadcasting the current winning bid.

18. The method of claim 16, wherein the step of receiving bids for the item through the network comprises receiving bids through a plurality of communication channels, including at least one of an Internet site, an email message, a text message, a voice message, a multimedia message, and a micro-blogging service.

19. The method of claim 16, wherein the item associated with the event is an item that is used by at least one participant in the event.

20. The method of claim 16, further comprising the step of initiating bidding on additional items that gain significance during the course of the event.
